(19) United States
(12) Patent Application Publication
(10) Pub. No.: US 2025/0190711 A1
(43) Pub. Date: Jun. 12, 2025

(54) GENERATING UNSTRUCTURED DATA FROM STRUCTURED DATA

(71) Applicant: SAP SE, Walldorf (DE)

(72) Inventor: Andreas GERBER, Konigsbach (DE)

(21) Appl. No.: 18/533,378

(22) Filed: Dec. 8, 2023

(51) Int. Cl. G06F 40/40

(52) U.S. Cl. CPC G06F 40/40

(57) ABSTRACT

Briefly, embodiments of a system, method, and article for receiving a structured data file and extracting object information from the structured data file. A graph structure may be built based, at least in part, on the extracted object information. One or more sentences may be created by traversing paths of the graph structure. The one or more created sentences may be provided to a Large Language Model (LLM) processor to generate one or more enhanced sentences. The one or more enhanced sentences may be output.

### BACKGROUND

Natural language processing (NLP) is an interdisciplinary subfield of computer science and linguistics. NLP may provide computers and computing systems with the ability to support and manipulate speech. NLP combines computational linguistics, machine learning, and deep learning models to process human language.

A large language model (LLM) is a deep learning algorithm which may perform a variety of NLP tasks. LLMs use transformer models and may be trained using massive datasets to enable LLMs to recognize, translate, predict, or generate text or other content. A transformer model is a neural network that learns context and thus meaning by tracking relationships in sequential data like the words in this sentence.

NLP tools based on LLMs using transformer technology offer exciting new possibilities for working with unstructured documents. The technology may provide an ability to predict the next word in a sentence or phrase, complete sentences based on given text, translate text into different languages, summarize text, improve the quality of text, and cluster text documents, to name just a few examples among many. This technology also enables unstructured data, such as text documents, to be processed and semantically understood, including extracting intentions, features, and causal links within the text.

However, LLMs are primarily used on pure-text-based, unstructured documents. LLMs are incapable of being applied to structured data, such as configuration files or graph structures, because training an LLM relies on the ordering of words in a sentence, which is difficult to maintain in structured data such as Extensible Markup Language (XML) and JavaScript Object Notation (JSON) files, where the ordering of elements changes when files are stored. In contrast, tools for analyzing structured data process cross-references while reading a file to generate and visualize the graph structure without relying on the ordering of elements within the file.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates a system for converting structured data into an unstructured format for processing by an LLM according to an embodiment.

FIG. 2 illustrates a process for converting structured data into an unstructured format for processing by an LLM according to an embodiment.

FIGS. 3A-1, 3A-2, and 3A-3 collectively illustrate a portion of source code of an XML file according to an embodiment.

FIGS. 3B-1, 3B-2, and 3B-3 collectively illustrate a portion of source code of an XML file in which relevant data has been identified according to an embodiment.

FIG. 4 illustrates a directed graph which may be generated from the processed portion of the source code shown in FIGS. 3A-1, 3A-2, 3A-3, 3B-1, 3B-2, and 3B-3 according to an embodiment.

FIG. 5A illustrates a directed graph according to an embodiment.

FIGS. 5B-5D illustrate different walked paths of a directed graph according to embodiments.

FIG. 6 illustrates an embodiment of a functional block diagram showing text generation from a BPMN input.

FIG. 7 illustrates an Artificial Intelligence (AI) system according to an embodiment.

FIG. 8 illustrates a computing device according to an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments are directed to a system and process for generating unstructured data or text from structured data or a graph structure in a deterministic way. “Deterministic,” as used herein, refers to a process or algorithm which, given a particular input, will always produce the same output, such as with an underlying state machine always passing through the same sequence of states. By generating unstructured data or text in such a manner, the generated unstructured data may be used for training and processing by an LLM.

A “transformer,” as used herein, refers to a deep learning architecture which relies on a parallel multi-head attention mechanism. “Deep learning,” as used herein, refers to a class of machine learning algorithms which uses multiple layers to progressively extract higher-level features from a raw input. For example, in image processing, lower layers may identify edges, while higher layers may identify the concepts relevant to a human such as digits or letters or faces. From another angle to view deep learning, deep learning refers to “computer-simulated” or “automated” human learning processes from a source (e.g., an image of dogs) to a learned object (dogs).

A transformer may require less training time than previous recurrent neural architectures, such as long short-term memory (LSTM), by virtue of a parallelized processing of input sequence. Input text may be split into n-grams encoded as tokens and each token may be converted into a vector via looking up from a word embedding table. At each layer, each token may then be contextualized within the scope of a context window with other (unmasked) tokens via a parallel multi-head attention mechanism allowing the signal for key tokens to be amplified and less important tokens to be diminished.

A transformer is a deep learning model which adopts the mechanism of self-attention, differentially weighting the significance of each part of the input data. A transformer has an ability to perform many functions, such as predicting the next word and/or element in a phrase or grouping of words or elements and may perform sentence completion. A transformer may have an ability to perform translation, such as where a sequence of words or elements may be translated into another sequence, such as in a different language. A transformer may additionally have an ability to train relatively long text strings and get answers such as, e.g., performing support request. A transformer may also train long text and shrink it to a short summary by, e.g., performing intent and value extractions. A transformer may further perform auto clustering to, e.g., enable understanding or embedding of a high complexity.

A transformer may also perform attention generation to, e.g., determine on which parts of an input string to focus. A transformer may perform mapping of attentions between different inputs. A transformer may additionally allow for multiple predictions or determine a ranked list of results including probabilities and/or accuracy values. A transformer may convert non-contextual embedding in contextual embeddings. A transformer may also predict timeseries. An artificial neural network (ANN), on the other hand, can only cluster, whereas transformers (via a deep learning model) may create content. A transformer may additionally exhibit high performance in response and training time because of massive parallel algorithms.

“Unstructured data,” as used herein, refer to information, in many different forms, which does not follow conventional data models. Because unstructured data does not follow conventional data models, it is therefore difficult to store and manage in a mainstream relational database. The vast majority of new data being generated today is unstructured, prompting the emergence of new platforms and tools that are able to manage and analyze it. These tools enable organizations to more readily take advantage of unstructured data for business intelligence (BI) and analytics applications. Unstructured data has an internal structure but does not contain a predetermined data model or schema. Unstructured data may be textual or non-textual and may be human-generated or machine-generated. A common type of unstructured data is text. Unstructured text may be generated and collected in a wide range of forms, including word processing documents, email messages, PowerPoint™ presentations, survey responses, transcripts of call center interactions and posts from blogs and social media sites, to name just a few examples among many.

“Structured data,” as sued herein, refers to data that has a standardized format. For example, structured data in a standardized format may allow for efficient access by software and humans alike. Structured day may be tabular with rows and columns that clearly define data attributes. A graph is a non-linear data structure. A graph may comprise several nodes, also referred to as vertices. The nodes of a graph may be connected through edges. A graph in which a sense of a specific direction is associated with individual edges is referred to as a directed graph. A “directed graph,” as used herein, refers to a data structure which stores data in vertices or nodes. Such vertices may be connected and directed by edges. One vertex may be directed towards another vertex through an edge between them.

An LLM may be used on a pure text-based, unstructured document. However, if data is in a structured format, an LLM may be incapable of being applied to the structured data, such as a graph structure, because training an LLM relies on the ordering of words in a sentence, which is difficult to maintain in structured data such as XML and JSON files, where the ordering of elements changes when files are stored. For example, tools for structured data may process cross-references while reading a file, generating and visualizing the graph structure without relying on the ordering of elements on the file structure.

Business Process Model and Notation (BPMN) is a graphical representation for specifying business processes in a business process model. BPMN is a standard for business process modeling which provides a graphical notation for specifying business processes in a Business Process Diagram based on a flowcharting technique. An objective of BPMN is to support business process management, for both technical users and business users, by providing a notation that is intuitive to business users, yet is also able to represent complex process semantics. The BPMN specification provides a mapping between the graphics of the notation and the underlying constructs of execution languages.

BPMN has been designed to provide a standard notation readily understandable by business stakeholders, typically including business analysts, technical developers and business managers. BPMN may therefore be used to support the generally desirable aim of stakeholders on a project adopting a common language to describe processes, helping to avoid communication gaps that can arise between business process design and implementation.

In accordance with an embodiment, structured data may be obtained and may be converted or transformed into an unstructured format. For example, the structured data may comprise a graph structure of a BPMN file. A BPMN file may be stored in an XML or JSON format, to name just a two formats among many for a BPMN file. After being converted or transferred into unstructured data, the unstructured data may be processed by an LLM. For example, sentences of unstructured data may be created from structured data, such as a directed graph, and text of the generated sentences may subsequently be enhanced with an LLM.

To translate or generate text, such as based on an input string comprising a sentence or phrase of text, an order of words in the sentence or phrase may be relatively important. For example, the importance of each word of the sentence may have a particular value for determining the meaning of the sentence based on the position of the word within the sentence.

Attention mechanism is a feature in deep learning, particularly for NLP tasks such as machine translation. An attention mechanism may encode an input sequence to one fixed length vector from which to decode the output at each time step. An attention mechanism may be used to align words in a sentence or phrase for translation. In accordance with an attention mechanism, a model may attempt to predict the next word in a sentence by searching for a set of positions in a source sentence where the more relevant information is concentrated. Such a model may predict the next word based on context vectors associated with these source positions and previously generated target words. Accordingly, instead of encoding an input sequence into a single fixed context vector, an attention mechanism or model may develop a context vector which is filtered specifically for each output time step.

Attention may be considered because when the model tries to predict an output word, it may only use parts of an input where the more relevant information is concentrated instead of an entire sentence, e.g., such a model attempts to give more importance to the few input words. Moreover, if a statement is comprised of seven words, changing the order of the words may form a question and may therefore change the meaning of the sentence from a statement to a question.

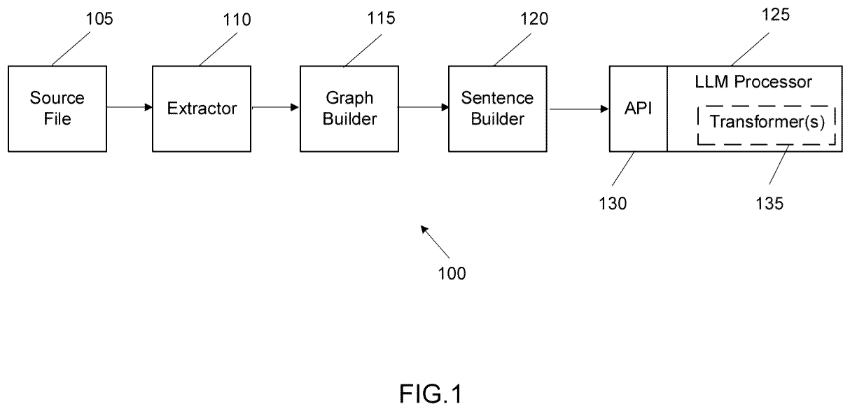

FIG. 1 illustrates a system 100 for converting structured data into an unstructured format for processing by an LLM according to an embodiment. System 100 includes various entities, including a source file 105. Source file 105 may comprise a file in which BPMN information may be represented. Source file 105 may comprise an XML, JSON, or any other type of file capable of representing structured data such as BPMN information.

System 100 of FIG. 1 includes additional entities, such as an extractor 110, a graph builder 115, a sentence builder 120, and an LLM processor 125. LLM processor 125 may acquire information from sentence builder 120 via an Application Programming Interface (API) 130. LLM processor 125 may include one or more transformers 135 to transform an input sequence to an output sequence, such as for speech recognition, text-to-speech transformation, or content generation, to name just a few examples among many.

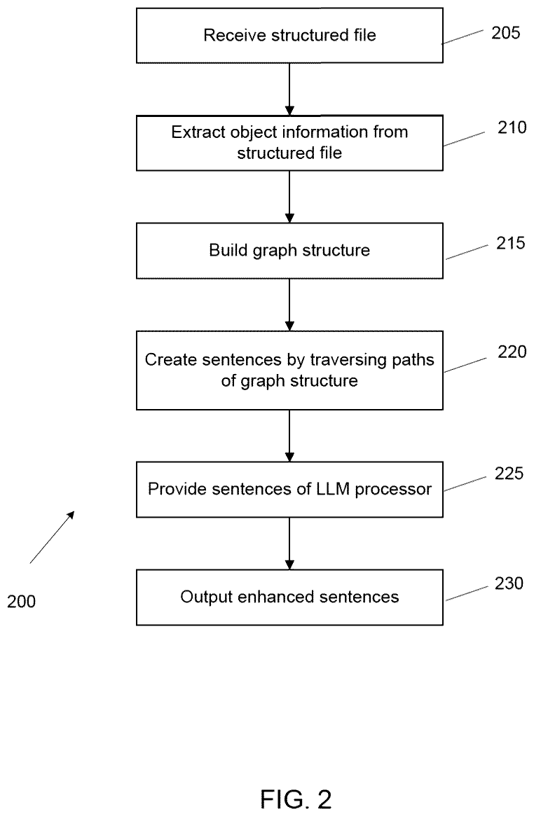

FIG. 2 illustrates a process 200 for converting structured data into an unstructured format for processing by an LLM according to an embodiment. Process 200 may be performed by system 100 of FIG. 1, for example. Embodiments in accordance with claimed subject matter may include all of, less than, or more than operations 205 through 230. Also, the order of operations 205 through 230 is merely an example order. For example, a method in accordance with process 200 may be performed by a computing device having one or more processors.

At operation 205, a source file 105 comprising structured data may be received or imported to an extractor 110. At operation 210, object-related information or other relevant data may be extracted from the source file 105, such as by extractor 110. For example, the relevant data may comprise data to build a graph structure from the source file 105. In accordance with an embodiment, various object-related information may be extracted from source file 105 in order to be able to build a graph structure. Such object-related information may include object names, types, relations or links to other objects and descriptions, for example.

At operation 215, a graph structure may be built from the extracted data, such as by graph builder 115. The graph structure may comprise a fully directed and connected graph structure, for example. The graph structure may represent relationships and connections between different data points in the graph structure. The graph structure may comprise different paths which may be walked.

At operation 220, sentences may be created by traversing or walking each path of the graph structure, such as by sentence builder 120. For example, for each path of a graph structure from a starting node to an ending node, the names of the nodes and intervening elements of the path of the graph structure may form a sequence of words or a string comprising a sentence.

At operation 225, the sentences may be provided to an LLM processor 125. For example, sentences may be provided by sentence builder 120 to an API 130. The LLM processor 125 may, in turn, acquire the sentences from the API 130. LLM processor 125 may enhance the text of the sentences, such as to make the enhanced sentences more readable and understandable for humans. In enhancing the sentences with text, LLM processor 125 may add causal references to make the sentences more natural to a human reader. However, the generated text may still maintain a requisite pattern and format useful for training the LLM.

At operation 230, the enhanced sentences may be output. For example, the enhanced sentences may be presented to a user on a display or may be converted into audio format and presented to the user, for example.

FIGS. 3A-1, 3A-2, and 3A-3 collectively illustrate a portion of source code 300 of an XML file according to an embodiment. As discussed above, an XML file may include information regarding various objects and relationships between the objects which may be utilized to generate a graph structure, such as a directed graph in accordance with BPMN. However, an XML file may also include various additional information which is irrelevant to the creation of a graph structure, such as header information and other support structure of the XML file. For example, the XML source code may include various information to form a complete XML file, such as information on how to read the document and what the schema is, but which does not describe content thereof. In order to extract relevant data from the XML file, such as is performed in operation 210 of process 200. To identify the relevant data from XML file, a determination is made as to which objects are related to each other.

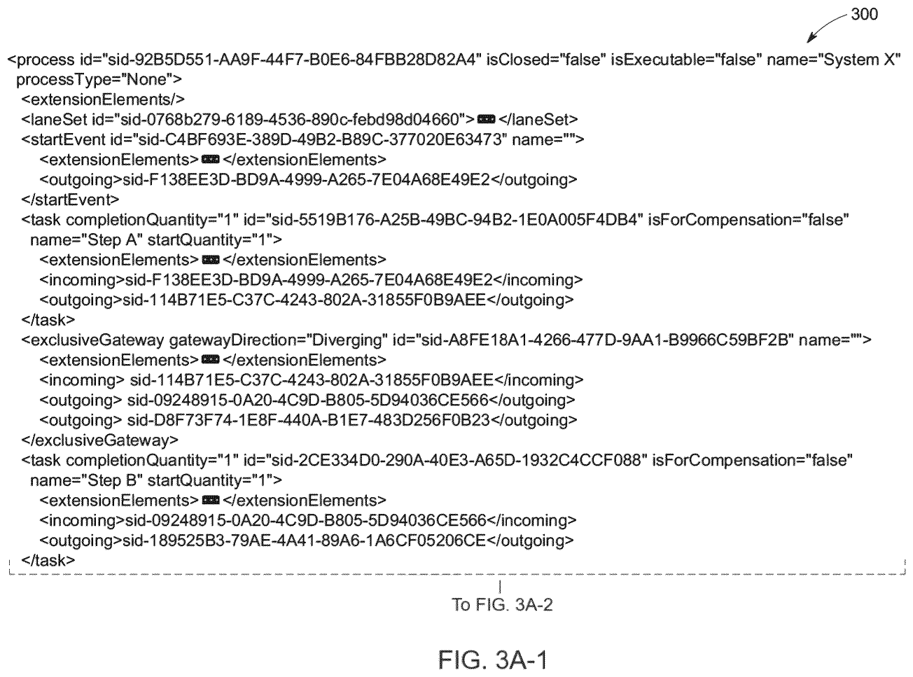

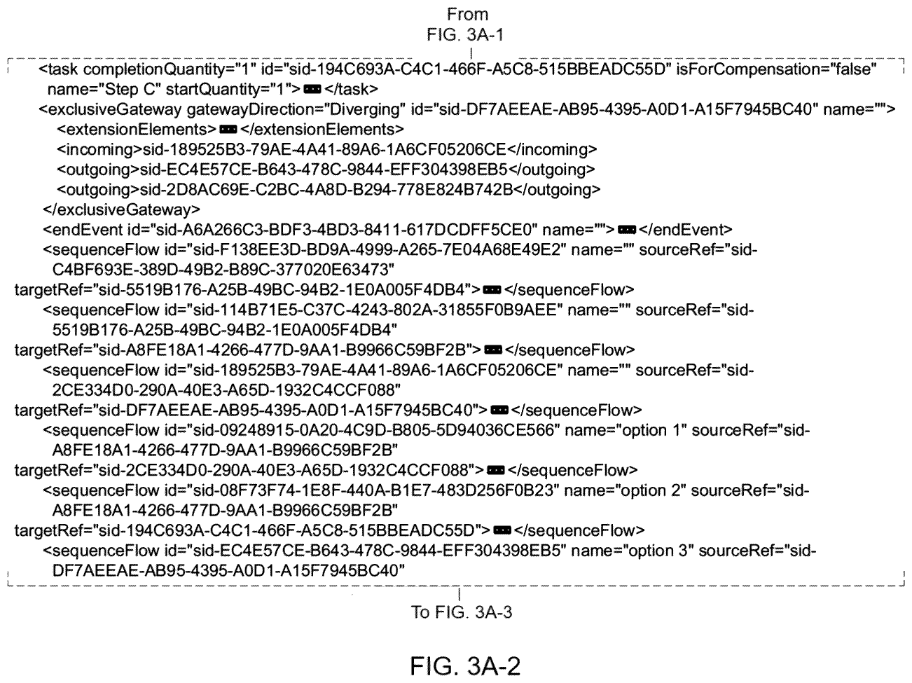

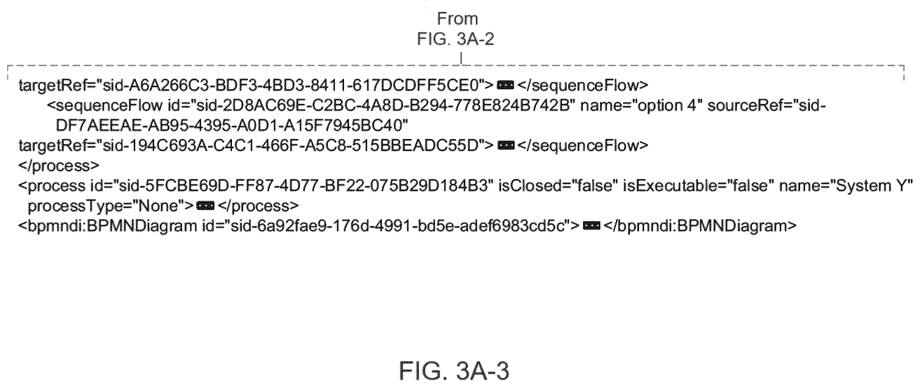

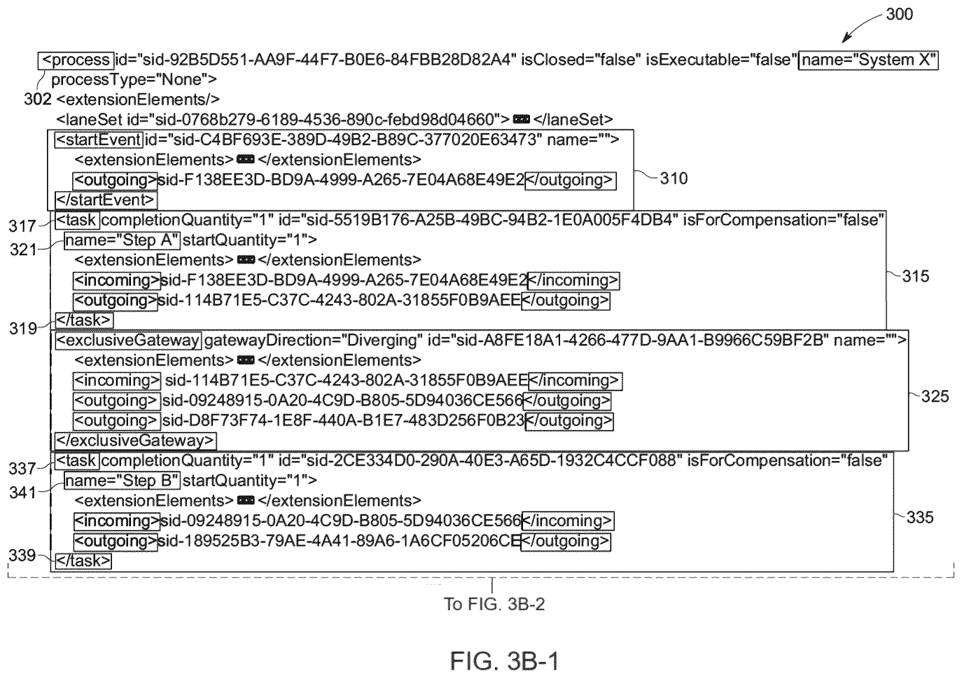

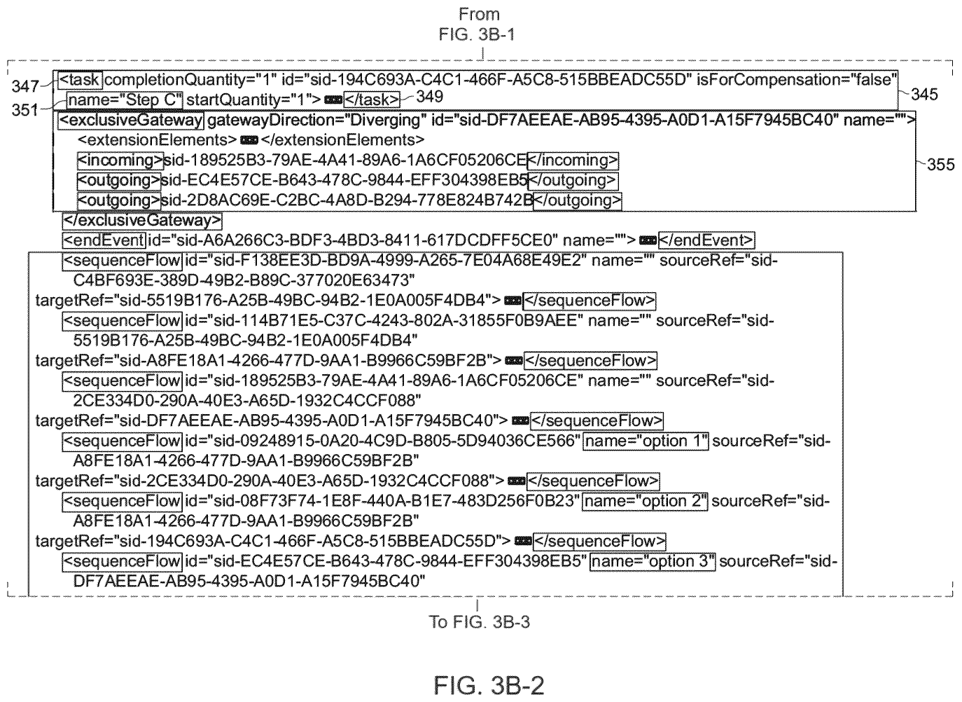

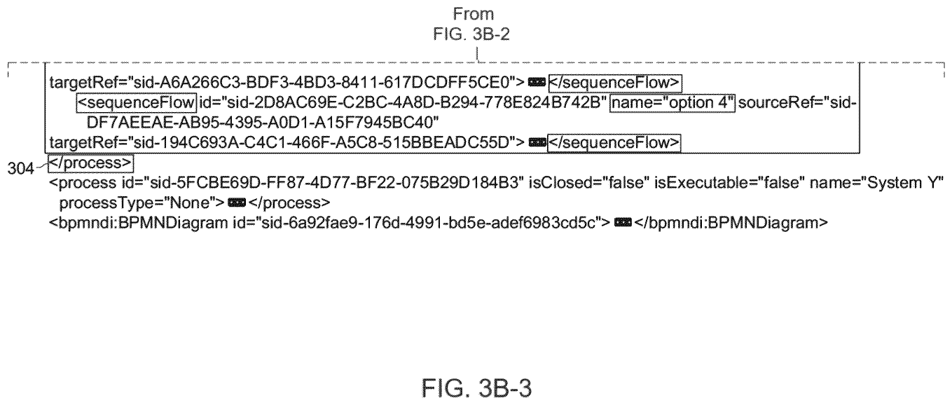

FIGS. 3B-1, 3B-2, and 3B-3 collectively illustrate the portion of source code 300 of the XML file in which relevant data has been identified according to an embodiment. As illustrated, various XML tags have boxes around them, indicating that they represent relevant data for generating a graph structure, For example, a process is shown in the XML portion of source code 300 of FIGS. 3B-1, 3B-2, and 3B-3. In FIG. 3B-1, a process opening tag 302 and a process closing tag 304 may be identified for a process. Other portions of the XML source code shown in FIGS. 3B-1, 3B-2, and 3B-3 may be processed to generate a graph structure for the process. For example, the elements and/or other portions of the graph structure may be determined by identifying various objects and relations between the objects of source code 300.

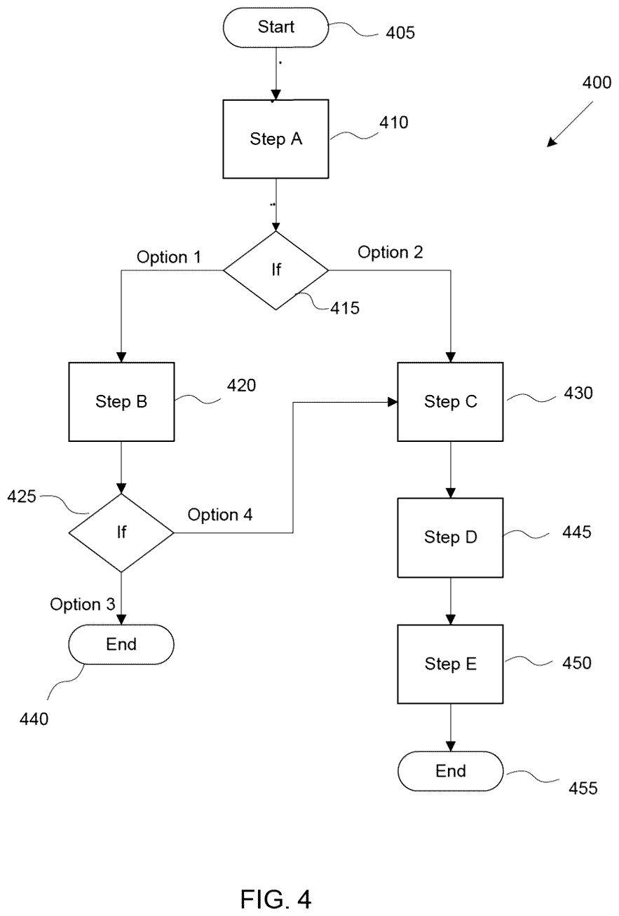

FIG. 4 illustrates a directed graph 400 which may be generated from the processed portion of the source code 300 shown in FIGS. 3A-1, 3A-2, 3A-3, 3B-1, 3B-2, and 3B-3 according to an embodiment.

After determining that the source code 300 shows a process, the various elements or nodes of the process may be determined from source code 300. For example, the source code 300 may be processed to identify the first element or step of the process. In accordance with an embodiment, object labels within source code grouping 310 may be used to initiate the identified process. The object labels within source code grouping 310 may be used to generate the start node 405 shown in directed graph 400.

Object labels within source code grouping 315 may be processed to determine a “Step A” step 410 shown in directed graph 400. For example, a task opening tag 317 and a task closing tag 319 may be utilized to identify the labels relating to “Step A.” Moreover, a name tag 321 may identify the name of the task or step, which is “Step A” in this example.

Object labels within source code grouping 325 may be processed to determine the next element or item of directed graph 400. In this example, the next item of directed graph 400 is a first exclusive gateway 415 which has two outgoing paths, e.g., “option 1,” and “option 2.” The object labels within source code grouping 325 indicate how this first exclusive gateway is constructed and identify an incoming path as well as two different potential outgoing paths. Moreover, the flow via “option 1” or “option 2” from first exclusive gateway 415 may be described in source code grouping 330.

Object labels within source code grouping 335 may be processed to determine a “Step B” step 420 shown in directed graph 400. For example, a task opening tag 337 and a task closing tag 339 may be utilized to identify the labels relating to “Step B.” Moreover, a name tag 341 may identify the name of the task or step, which is “Step B” in this example.

Object labels within source code grouping 345 may be processed to determine a “Step C” step 430 shown in directed graph 400. For example, a task opening tag 347 and a task closing tag 349 may be utilized to identify the labels relating to “Step C.” Moreover, a name tag 351 may identify the name of the task or step, which is “Step C” in this example.

Object labels within source code grouping 355 may be processed to determine a second exclusive gateway 425 which has two outgoing paths, e.g., “option 3,” and “option 4.” The object labels within source code grouping 355 indicate how this first exclusive gateway is constructed and identify an incoming path as well as two different potential outgoing paths. Moreover, the flow via “option 3” or “option 4” from second exclusive gateway 425 may be described in source code grouping 330.

Additional portions of source code 300 not shown in FIG. 3A-1, 3A-2, 3A-3, 3B-1, 3B-2, or 3B-3 may be further processed to identify additional elements of directed graph 400, such as Step D 445, Step E 450, first end node 440, and second end node 455.

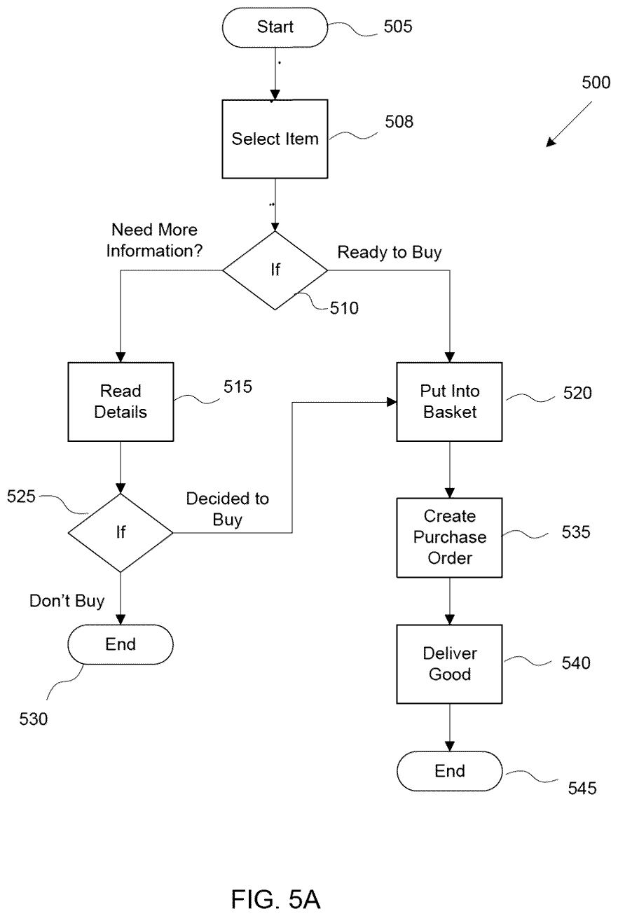

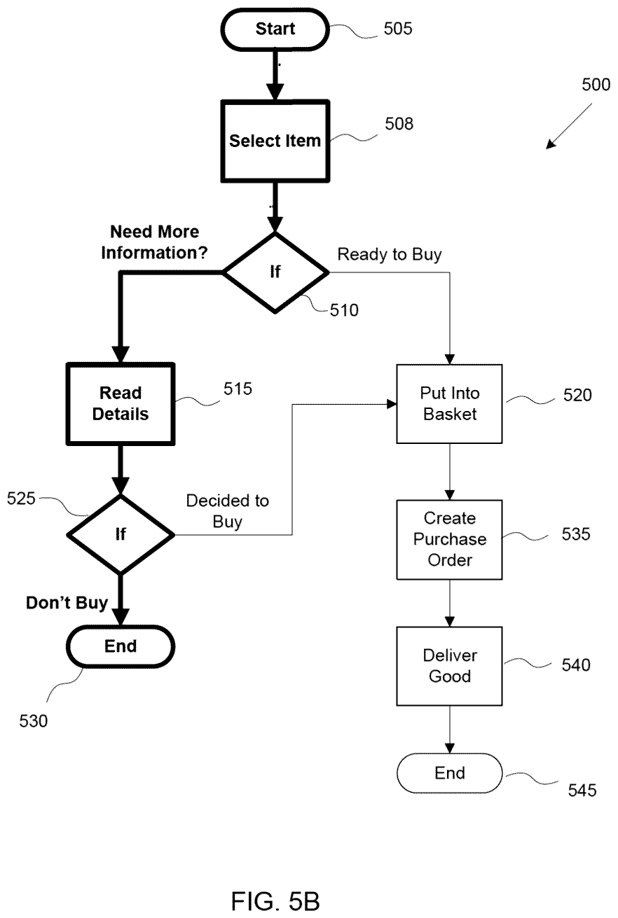

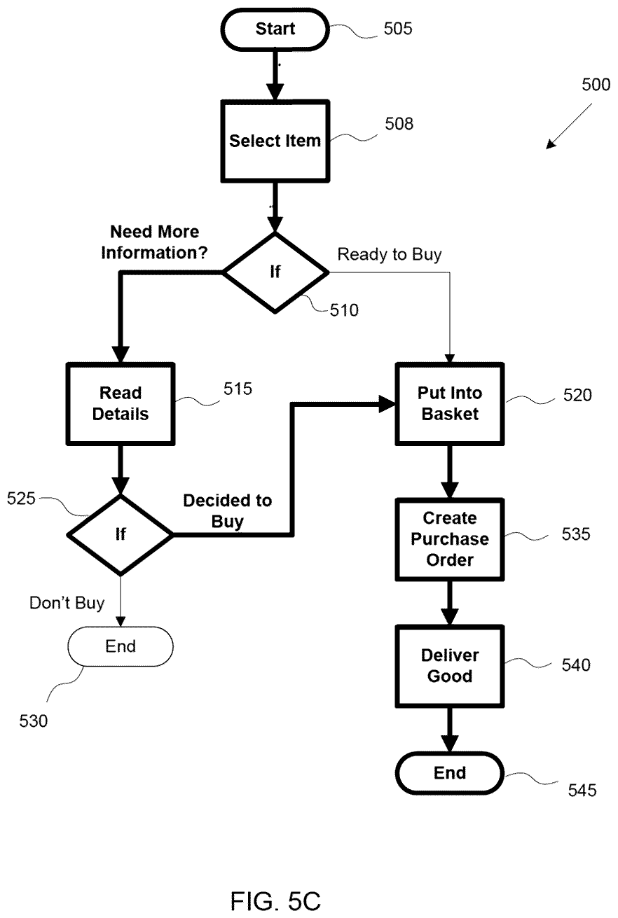

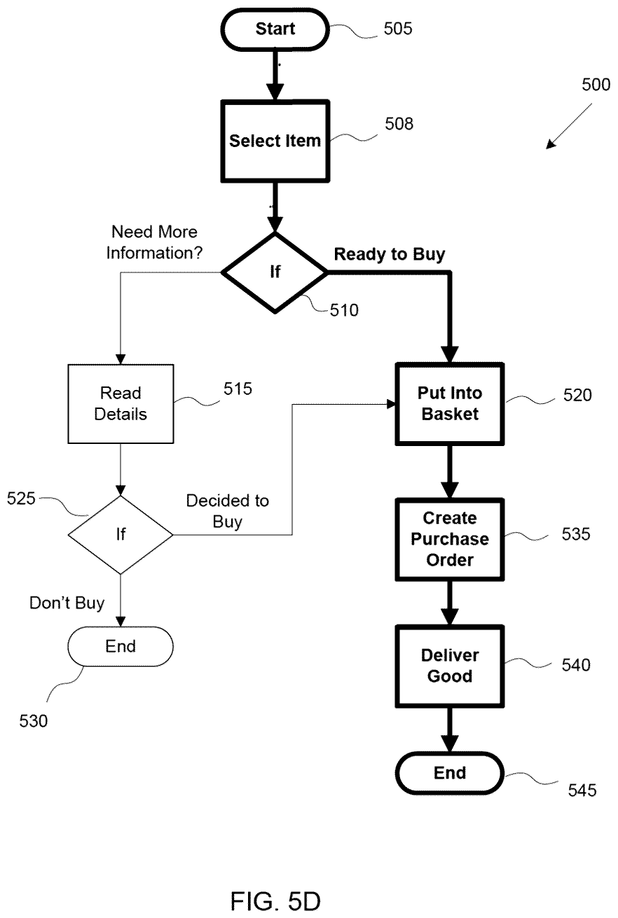

FIG. 5A illustrates a directed graph 500 according to an embodiment. Directed graph 500 may be created from source code, such as XML or JSON, which has been processed to extract relevant object-related data, such as is discussed above with respect to process 200 of FIG. 2. Directed graph 500 includes a relatively smally number of elements for the sake of simplicity. However, it should be appreciated that in some embodiments, a graph structure having more or fewer elements than that shown in directed graph 500 may be generated and/or otherwise utilized. Directed graph 500 may include a start node 505, a “Select Item” step 508, a first exclusive gateway 510 having a “Need More Info?” pathway to a “Read Details” step 515, and a “Ready to Buy” pathway to a “Put Into Basket” step 520. A second exclusive gateway 525 is disposed after “Read Details” step 515. Second exclusive gateway 525 has two output pathways-a “Don't Buy” pathway from second exclusive gateway 525 leads to first end node 530. A “Decided to Buy” pathway leads from second exclusive gateway 525 to “Put Into Basket” step 520. A “Create Purchase Order” step 535 is disposed after “Put Into Basket” step 520 and leads to “Deliver Good” step 540. After “Deliver Good” step 540 is a second end node 545.

Different sentences may be formed by walking directed graph 500 and choosing different options at first exclusive gateway 510 or second exclusive gateway 525. FIGS. 5B-5D illustrate different walking paths for directed graph 500 according to embodiments. In FIGS. 5B-5D, bold lines are included to show how directed graph 500 is being walked.

In FIG. 5B, directed graph 500 is walked in a direction which starts at start node 505, performs the “Select Item” step 508, selects the “Need More Info?” pathway at first exclusive gateway 510, performs “Read Details” step 515, selects the “Don't Buy” pathway from second exclusive gateway 525, and completes at first end node 530. If directed graph 500 is walked as shown in FIG. 5B, a sentence may be formed which comprises: “Select an item, if more information is needed, read details, and if user decided not to buy, the process ends.”

In FIG. 5C, directed graph 500 is walked in a direction which starts at start node 505, performs the “Select Item” step 508, selects the “Need More Info?” pathway at first exclusive gateway 510, performs “Read Details” step 515, selects the “Decided to Buy” pathway from second exclusive gateway 525, performs the “Put Into Basket” step 520, performs the “Create Purchase Order” step 535, performs the “Deliver Good” step 540, and completes at second end node 545. If directed graph 500 is walked as shown in FIG. 5C, a sentence may be formed which comprises: “Select an item, if more information is needed, read details, and if user decided to buy, put item into basket, create a purchase order, deliver good, and the process ends.”

In FIG. 5D, directed graph 500 is walked in a direction which starts at start node 505, performs the “Select Item” step 508, selects the “Ready to Buy” pathway at first exclusive gateway 510, performs the “Put Into Basket” step 520, performs the “Create Purchase Order” step 535, performs the “Deliver Good” step 540, and completes at second end node 545.

“Read Details” step 515, selects the “Decided to Buy” pathway from second exclusive gateway 525, performs the “Put Into Basket” step 520, performs the “Create Purchase Order” step 535, performs the “Deliver Good” step 540, and completes at second end node 545. If directed graph 500 is walked as shown in FIG. 5D, a sentence may be formed which comprises: “Select an item, if the user is ready to buy, put item into basket, create a purchase order, deliver good, and the process ends.”

The sentences created from directed graph 500 as shown above in FIGS. 5B-5D have been created while starting at start node 505 and ending at first end node 530 or second end node 545. However, it should be appreciated that it some implementations, a sentence may be created which starts at an item other than start node 505. For example, a sentence may be created which starts at a decision point, such as first exclusive gateway 510 or second exclusive gateway 525. If there is a relatively large number of steps and/or decision points in a directed graph, a generated sentence may be more readable and potentially more useful if sentences are started from decision points instead of from start node 505, for example.

After sentences have been created from directed graph 500, as shown above in FIGS. 5B-5D, the sentences may be enhanced to make them more readable. For example, one relatively long sentence may be created for each path along which the directed graph 500 has been walked. The sentences may be enhanced by breaking a relatively long sentence into shorter sentences and punctuation may be added, for example, to make the sentences more readable to a human user. For example, the sentences may be enhanced in such a way that a human reading the created sentence might be unaware that the sentences were created by processing a graph structure. For example, a sentence created by walking the directed graph 500 as shown in FIG. 5B is “Select an item, if more information is needed, read details, and if user decided not to buy, the process ends.” This sentence may be enhanced by an LLM to transform this relatively long sentence into a phrase such as “The user selects an item. If the user decides that more information is needed, the user may read details for the item. If the user decides not to buy the item, then the process ends.” In one aspect, an LLM may be used to transform sentences or phrases which may be relatively long and/or may include a relatively large or potentially distracting amount of the same repeated word(s) into sentences which have a more conversational tone. For example, an LLM may transform text into a format which is more similar to how a human would write a sentence.

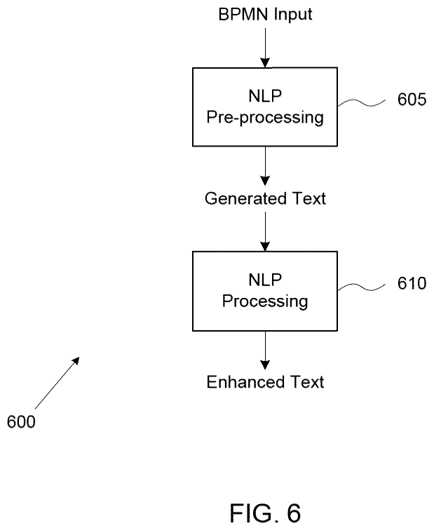

FIG. 6 illustrates an embodiment 600 of a functional block diagram showing text generation from a BPMN input. As illustrated, a BPMN input may be provided an NLP pre-processing block 605. As discussed above, a BPMN input may comprise a file in which structured data is presented, such as an XML or JSON file. NLP pre-processing block 605 may perform operations including extracting meaningful/relevant information from the BPMN input, such as step names, step types, and input and output connections for a directed graph. NLP pre-processing block 605 may also generate one or more directed graphs from the extracted content and may generate sentences by walking the directed graphs in different directions, such as is discussed above with respect to FIGS. 5A-5D. NLP processes may also be employed to convert the structured data from the BPMN input into unstructured data.

NLP pre-processing block 605 may output generated text, such as in the form of sentences, to NLP processing block 610. NLP processing block 610 may perform various actions to enhance the generated text, such as performing a similarity check or performing a next step/sequence recommendation for sentence completion. NLP processing block 610 may perform additional operations such as clustering, to name just one example among many.

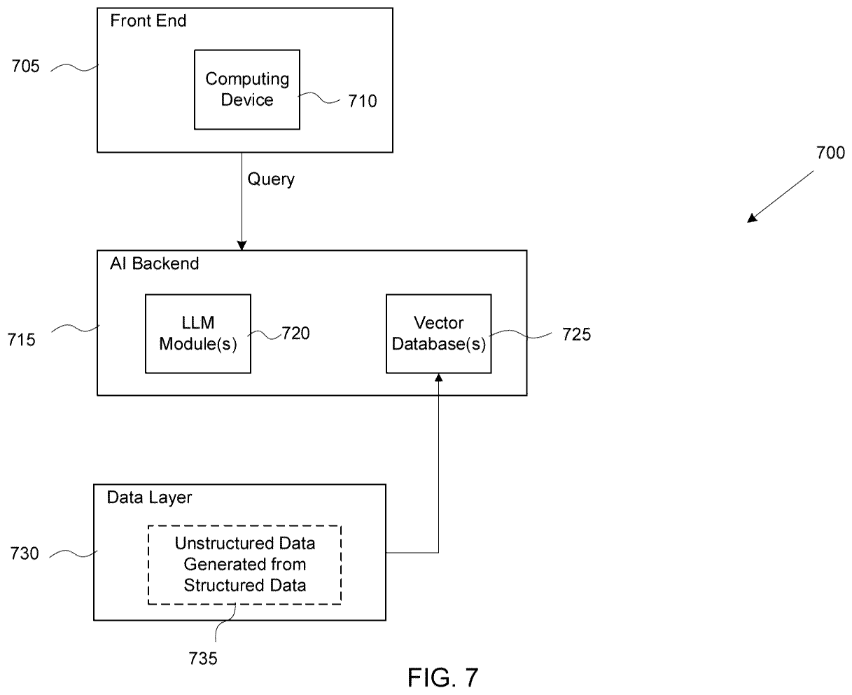

FIG. 7 illustrates an Artificial Intelligence (AI) system 700 according to an embodiment. AI system 700 may include a Frontend 705 having a computing device 710. For example, a user may submit a query via computing device 710 through the use of a user input device, such as a keyboard and/or computer mouse. The query may be provided to an AI backend 715. The AI backend 715 may include components such as LLM module(s) 720, which may implement LLM processing based on the received query and may generate automated responses to the query, fir example. AI backend may include vector database(s) 725, which may comprise previously analyzed or processed data, such as previously submitted queries or analyzed text.

A data layer 730 may be utilized to provide unstructured data 735 which has been previously generated from structured data. For example, a process as described above with respect to FIG. 2 may have been performed to generated unstructured data from structured data, such as a directed graph or BPMN file. The generated unstructured data 735 may be provided to vector database(s) 725 to increase or otherwise enhance the knowledge based of the vector database(s) 725 of AI backend 715.

If an end user of AI backend 715 has no control over the use of vector database(s) 725, privacy concerns may arise if BPMN files were provided directly to vector database(s) 725 for use by AI backend 715. However, an end user's privacy may be better protected if unstructured data is generated based on structured data and the generated unstructured data is provided to vector database(s) instead of directly providing the BPMN files.

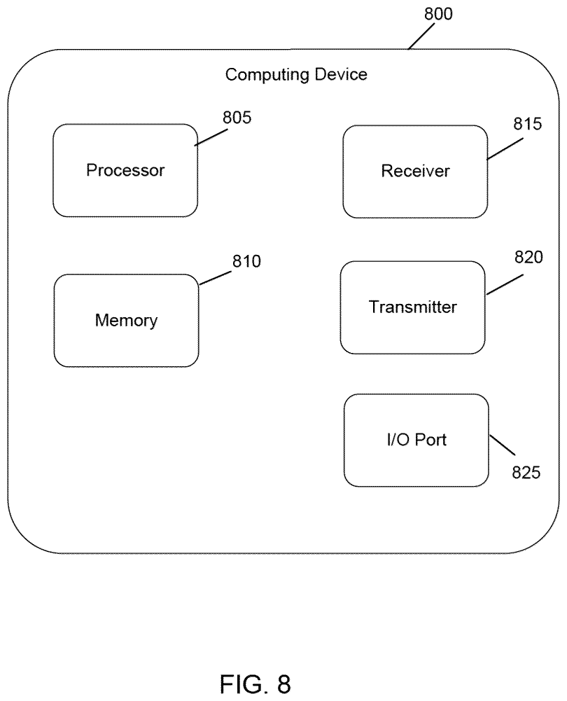

FIG. 8 illustrates a computing device 800 according to an embodiment. Computing device 800 may include a processor 805. Computing device 800 may include additional components, such as a memory 810, a receiver 815, a transmitter 820, and an Input/Output (I/O) port 825. Processor 805 may execute computer-executable code stored in memory 810 to perform various operations. For example, computing device 800 may communicate via a server or another computing device via receiver 815, transmitter 820, and/or I/O port 825.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
receiving a structured data file;
extracting object information from the structured data file;
building a graph structure based, at least in part, on the extracted object information;
creating one or more sentences by traversing paths of the graph structure;
provide the one or more created sentences to a Large Language Model (LLM) processor to generate one or more enhanced sentences; and
output the one or more enhanced sentences.

2. The method of claim 1, wherein the structured data file comprises an Extensible Markup Language (XML) file or a JavaScript Object Notation (JSON) file.

3. The method of claim 1, wherein the LLM processor employs one or more transformers.

4. The method of claim 1, wherein the object information comprises one or more of object labels, process pathways, or decision points.

5. The method of claim 1, wherein the structured data file comprises a directed graph.

6. The method of claim 1, further comprising saving the one or more enhanced sentences as an unstructured data file.

7. The method of claim 1, wherein the one or more enhanced sentences comprise textual data.

8. The method of claim 1, further comprising the LLM processor performing Natural Language Processing on the one or more created sentences.

9. A system, comprising:
an extractor to receive a structured data file and extract object information from the structured data file;
a graph builder to build a graph structure based, at least in part, on the extracted object information;
a sentence builder to create one or more sentences by traversing paths of the graph structure; and
a Large Language Model (LLM) processor to generate one or more enhanced sentences based, at least in part, on the one or more created sentences.

10. The system of claim 9, wherein the structured data file comprises an Extensible Markup Language (XML) file or a JavaScript Object Notation (JSON) file.

11. The system of claim 9, wherein the LLM processor employs one or more transformers.

12. The system of claim 9, wherein the object information comprises one or more of object labels, process pathways, or decision points.

13. The system of claim 9, wherein the structured data file comprises a directed graph.

14. The system of claim 9, wherein the one or more enhanced sentences comprise textual data.

15. The system of claim 9, wherein the LLM processor is to further perform Natural Language Processing on the one or more created sentences.

16. An article, comprising:
a non-transitory storage medium comprising machine-readable instructions executable by a processor to perform:
receiving a Business Process Model and Notation (BPMN) file;
extracting object information from the BPMN file;
building a graph structure based, at least in part, on the extracted object information;
creating one or more sentences by traversing paths of the graph structure;
using Large Language Model (LLM) processor to generate one or more enhanced sentences based on the one or more created sentences; and
outputting the one or more enhanced sentences.

17. The article of claim 16, wherein the BPMN file comprises an Extensible Markup Language (XML) file or a JavaScript Object Notation (JSON) file.

18. The article of claim 16, wherein the object information comprises one or more of object labels, process pathways, or decision points.

19. The article of claim 16, wherein the BPMN file comprises a directed graph.

20. The article of claim 16, wherein the machine-readable instructions are further executable by the processor to perform Natural Language Processing on the one or more created sentences.
